(19) United States
(12) Patent Application Publication
(10) Pub. No.: US 2006/0253353 A1
(43) Pub. Date: Nov. 9, 2006

(54) Method and system for crossing orders

(75) Inventor: David M. Weisberger, Far Hills, NJ (US)

Correspondence Address: MILBANK, TWEED, HADLEY & MCCLOY, 1 CHASE MANHATTAN PLAZA, NEW YORK, NY, 10005-1413, US

(73) Assignee: Citigroup Global Markets, Inc.

(21) Appl. No.: 11/121,598

(22) Filed: May 4, 2005

(51) Int. Cl. G06Q 40/00

(52) U.S. Cl. 705/35

(57) ABSTRACT

The invention provides methods and systems for crossing securities orders. A first order to buy or sell a particular security is received, the first order including at least information reflecting quantity of the first order. A second order to buy or sell the security is received, the second order including at least information reflecting price of the second order and information reflecting quantity of the second order, wherein the first order and second order are compatible for a cross. A crossing size is identified as a quantity of the second order that is less than or equal to the quantity of the first order. An excess size is identified as a quantity of the second order that is greater than the quantity of the first order. A third order is created for the security, the third order having at least information reflecting a quantity that is equal to the excess size. The third order is sent to a securities market for execution, and a best bid or best offer price is determined for the security. The crossing size is executed at the best bid price or the best offer price.

### BACKGROUND

The invention relates to the field of securities transactions, and more particularly to the field of automated order matching or crossing, with incentives for market makers and liquidity providers to enter and leave orders in the system.

Order matching and crossing systems are known, however many of those system lack sufficient incentive for market makers and liquidity providers to enter and leave orders in the system without suffering inferior execution prices. What is needed are systems and methods that provide such incentives.

The preceding description is not to be construed as an admission that any of the description is prior art relative to the present invention.

### SUMMARY OF THE INVENTION

In one embodiment, the invention provides a method and system for crossing securities orders, comprising receiving a first order to buy or sell a particular security, the first order including at least information reflecting quantity of the first order. The method and system further comprise receiving a second order to buy or sell the security, the second order including at least information reflecting price of the second order and information reflecting quantity of the second order, wherein the first order and second order are compatible for a cross. The method and system further comprise identifying as a crossing size a quantity of the second order that is less than or equal to the quantity of the first order, and identifying as an excess size a quantity of the second order that is greater than the quantity of the first order. The method and system further comprise creating a third order for the security, the third order having at least information reflecting a quantity that is equal to the excess size. The method and system further comprise sending the third order to a securities market for execution, determining a best bid or best offer price for the security, and executing the crossing size of the second order at best bid or best offer price.

In one embodiment, the method and system further comprise reporting the execution of the crossing size with the execution price. In one embodiment, the method and system further comprise determining an execution price of the third order executed at the securities market. In one embodiment, the method and system further comprise sending a report of the execution of the third order, the report including the execution price of the third order. In one embodiment of the method and system, determining the best bid or best offer price for the security occurs after determining an execution price of the third order. In one embodiment of the method and system, the second order is a market order. In one embodiment of the method and system, the second order is a limit order. In one embodiment of the method and system, the first order is a firm order. In one embodiment of the method and system, the third order is a limit order. In one embodiment of the method and system, the third order is a market order. In one embodiment of the method and system, the securities market is the listing market for the security. In one embodiment of the method and system, the securities market is not the listing market for the security. In one embodiment of the method and system, the best bid or best offer price is the national best bid or best offer price. In one embodiment of the method and system, the first order is received from a first party and the second order is received from a second party, further comprising withholding all information about the first order from the second party until after executing the crossing size. In one embodiment of the method and system, the first order is received from a first party and the second order is received from a second party, further comprising withholding all information about the second order from the first party until after executing the crossing size. In one embodiment of the method and system, the first order is locked-in before sending the third order to the securities market for execution.

In one embodiment, the invention provides a method and system for crossing securities orders, comprising receiving a plurality of first orders to buy or sell a particular security, the first orders including at least information reflecting quantity of the first orders and predetermined cross size thresholds. The method and system further comprise receiving a second order to buy or sell the security, the second order including at least information reflecting price of the second order and information reflecting quantity of the second order, wherein at least two of the first orders and the second order are compatible for a cross. The method and system further comprise identifying one of the plurality of first orders as having a highest priority, and determining whether the quantity of the second order is greater than the predetermined cross size threshold of the highest priority first order. The method and system further comprise responsive to determining whether the quantity of the second order is greater than the predetermined cross size threshold of the highest priority first order, identifying one of the plurality of first orders as having a next highest priority. The method and system further comprise determining whether the quantity of the second order is greater than the predetermined cross size threshold of the next highest priority first order.

In one embodiment of the method and system, priority of the first order is based on time of the order. In one embodiment of the method and system, priority of the first order is based on size of the order. In one embodiment, the method and system further comprise identifying as a crossing size a quantity of the second order that is less than or equal to the quantity of the next highest priority first order. In one embodiment, the method and system further comprise determining a best bid or best offer price for the security, and executing the crossing size of the second order at best bid or best offer price. In one embodiment, the method and system further comprise identifying as an excess size a quantity of the second order that is greater than the quantity of the next highest priority first order. In one embodiment, the method and system further comprise creating a third order for the security, the third order having at least information reflecting a quantity that is equal to the excess size, and sending the third order to a securities market for execution. In one embodiment, the method and system further comprise locking-in the next highest priority first order before executing the crossing size of the second order. In one embodiment, the method and system further comprise locking-in the next highest priority first order before sending the third order to a securities market for execution.

The foregoing specific objects and advantages of the invention are illustrative of those which can be achieved by the present invention and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates a system according to one embodiment of the invention;

FIG. 2 illustrates steps in a method according to one embodiment of the invention; and

FIG. 3 illustrates steps in a method according to one embodiment of the invention.

It is understood that the drawings are for illustration only and are not limiting.

### DETAILED DESCRIPTION OF THE DRAWINGS

In one embodiment, the invention provides an automated system and method to match or cross orders to buy and sell securities. The system and method help to provide better execution prices to liquidity providers and market makers in securities so they will have an incentive to enter orders into the system for matching or crossing.

For the different markets, there are a number of different types of market makers. At NYSE and AMEX, which have floor auctions for the sale of listed securities, the market makers are generally referred to as specialists, because they specialize in certain listed securities. At NYSE and AMEX, there is only one such market maker or specialist for each listed security. NASDAQ does not have a floor auction, and there is no single individual who specializes in each of the listed securities. Instead, there are a number of individuals or entities that regularly trade in NASDAQ listed securities, and collectively they act as market makers for those securities.

Systems and methods to match and cross securities orders are known. In those known systems and methods, liquidity demanders (the end clients) enter orders to buy or sell securities and those orders are matched or crossed with orders from other entities, such as other end clients, or entities that provide liquidity/market makers. Examples of these known systems and methods include POSIT®, Primex Trading®, and NYFIX Millennium®. These known systems and methods have enjoyed varying degrees of success. For liquidity providers, who are important parties to the successful operation of any matching or crossing system, one of the problems with some of these known systems is the lack of protection from large orders on the opposite side.

As an example, assume that in the market for a listed security, the best bid for a stock a “bid” is the price that someone will buy) is $20.05 for 500 shares (500 shares is the size of he bid), and the best offer (an “offer” is the price that someone will sell) is $20.06 for 1,000 shares (the size of the offer). Simplistically, this means that an end client who wants to sell up to 500 shares at the market price can sell them for $20.05 because 500 shares are bid at that price. Alternatively, an end client who wants to buy up to 1,000 shares at the market price can buy them for $20.06. This of course assumes that the end client gets their order in before someone else. Changing the example a little, if the end client instead wants to sell 1,500 shares, not just 500 shares, they would sell the first 500 shares at $20.05 (taking all of the bid), and the remaining 1,000 shares would probably trade at some lower price, maybe $20.04 or less.

Automated order matching or crossing systems are different than the floor auction of NYSE or AMEX, although many of the automated systems use the best bid and offer prices from a securities auction market to set the prices for the match or cross. In the known order matching or crossing systems, with a best bid of $20.05 for 500 shares at the auction market, a liquidity provider or market maker might be willing to buy 1,000 shares at the bid ($20.05) in the order matching or crossing system. If the liquidity provider enters that bid of $20.05 for 1,000 shares into one of the known matching/crossing systems, and a large order to sell 5,000 shares comes into the order matching or crossing system, the first 1,000 shares would go at $20.05 (from the matching/crossing system). Assuming there are no other bids close to the market in the automated matching system, the remaining 4,000 shares would go to the auction market, where 500 shares would go at the market's best bit ($20.05) and 3,500 shares would go at other price(s), such as $20.04 or less. This means that for a large order, the liquidity provider paid a higher (i.e., inferior) purchase price simply by putting their order into the matching/crossing system. This becomes a disincentive for the liquidity provider to put orders into an automated matching/crossing system and leave them.

The embodiments of the invention that are described herein help to provide an incentive to liquidity providers and market makers by ensuring that the liquidity provider and market maker do not pay or receive inferior prices.

An Example System

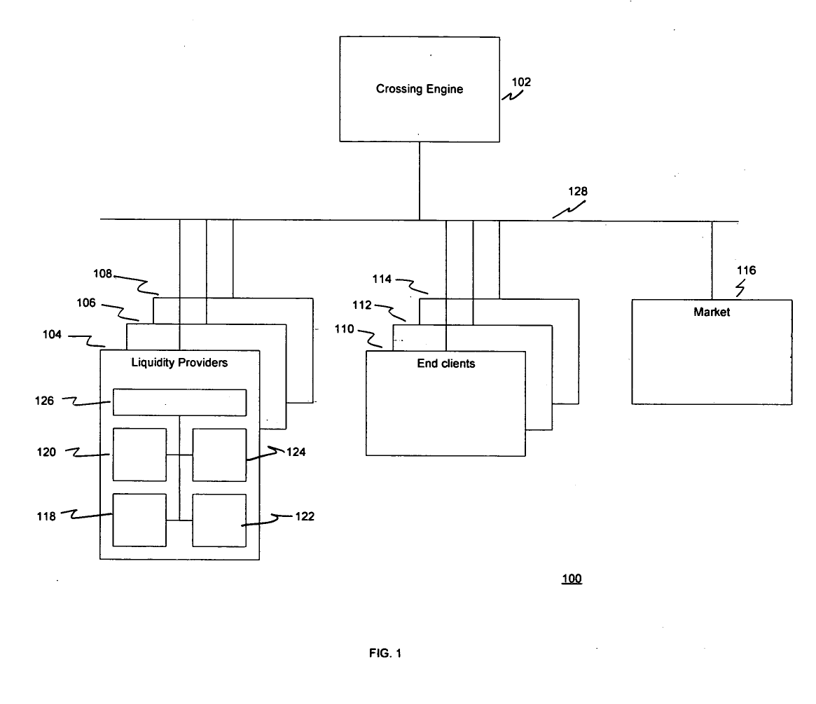

Referring to FIG. 1, system 100 according to one embodiment of the invention includes a plurality of parties (102 through 116). Crossing engine 102 includes most of the business logic for the various embodiments disclosed below. Parties 104, 106, and 108 are liquidity providers or market makers; parties 110, 112, and 114 are end clients; and party 116 is a securities auction market. The numbers of parties are illustrative only, and there may be multiple auction markets.

Most or all of parties 102 through 116 are interconnected by network 128. Although not illustrated, parties 102 through 116 each typically include computer elements, such as central processors (118), input-output devices (120), code storage devices (122), display devices (124), and network interconnection devices (126).

In various embodiments, central processors 118 include single processors in single computers, multiple processors in single computers, and multiple processors in multiple computers. Embodiments for input-output devices 120 include keyboards, pointing devices, and serial ports. Embodiments for code storage devices 122 include fixed or removable magnetic media (e.g., hard disk drives, or floppy drives); CD; DVD; or memory stick. Embodiments for display devices 124 include video monitors, LCDs, and printers. Network interconnection devices 126 include wired and wireless network connection cards. Although, there are many possible embodiments for central processors 118, input-output devices 120, code storage devices 122, display devices 124 and network interconnection devices 126, their precise form is not a particular feature of the invention embodiments, and equivalents of the described example embodiments are clearly envisioned.

An Example Method

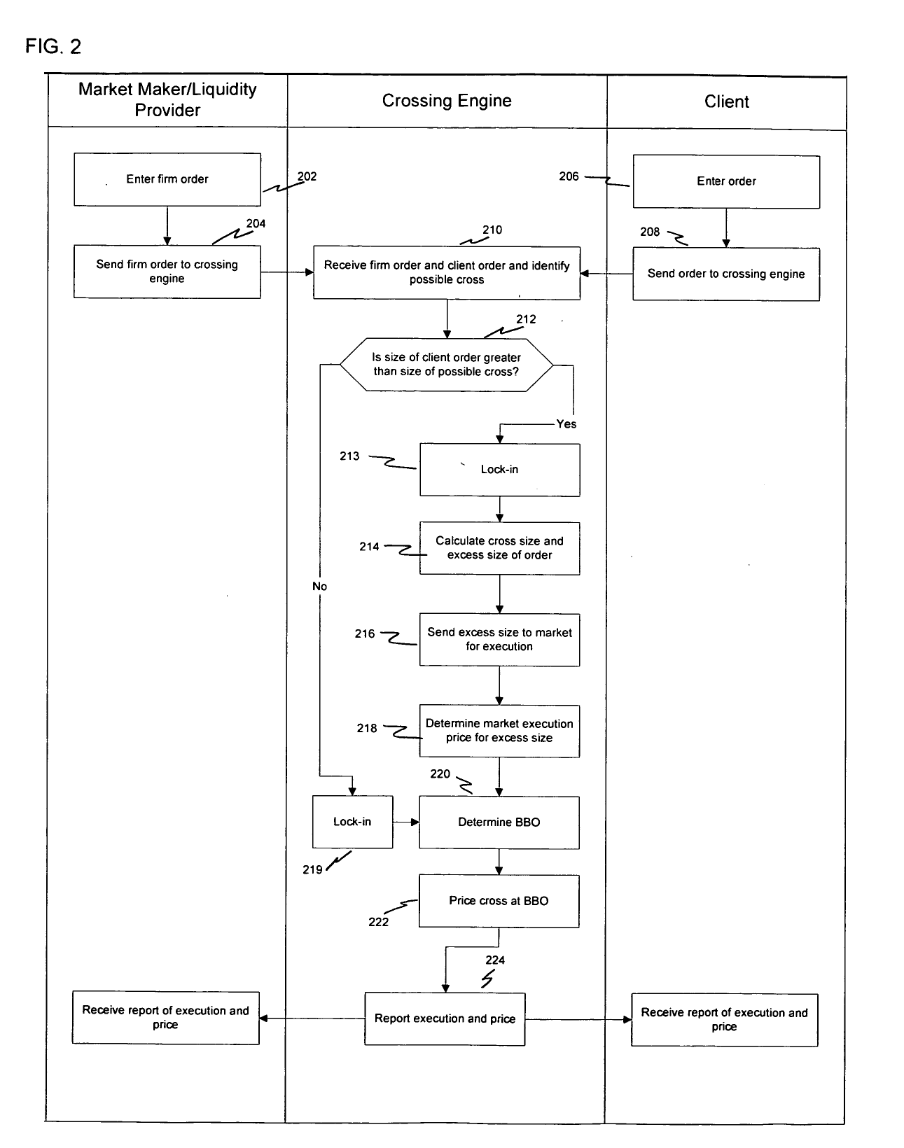

In this example, as illustrated in FIG. 2, at step 202, a market maker or liquidity provider (104), enters an order for a particular security. The order specifies a quantity or number of shares, which is sometimes called the order size. In one embodiment, the order does not include a specific price for the order. In this regard, the order is somewhat like a market order, which does not specify a price for execution. However, there is a difference, because in contrast to a typical market order, which is executed immediately at the market price, this order is entered and held by the crossing system to be matched or crossed with orders that are entered by end clients. For ease of reference the order is referred to herein as a “firm order.” As such, the “firm order” is an actual order for a number of shares, but there is no specific price on the order. End client orders can trade against the “firm order” as long as the terms are satisfied.

A “firm order” has some features that are similar to a “market not held order” as known at some auction markets. A “market not held order,” is a market order that the customer gives to a floor broker with the understanding that the floor broker will use their discretion and experience in executing the order in an effort to get a price that is superior to the current market price. If the market moves to a superior price, then the customer receives that superior price. If the market moves to an inferior price, then the broker is not held to the normal rule that all market orders be executed immediately. However, a “firm order” and a “market not held order” are different because a “firm order” is from a market maker or liquidity provider, and not from an end customer, and a “firm order” is not given to a floor broker. In addition, a “firm order” will only be executed against orders from end clients, and not against “firm orders” from other market makers or liquidity providers.

In one embodiment of the invention, the fact that a “firm order” is entered by market maker/liquidity provider 104 into crossing engine 102 is hidden from all other market makers or liquidity providers (106, 108). The fact of the “firm order” is also hidden from all end clients (110, 112, 114) until there is an execution.

At step 204, market maker/liquidity provider 104 sends the “firm order” to crossing engine 102.

At step 206, end client 110 enters an order, and at step 208, end client 110 sends the order to crossing engine 102. In one embodiment, the order that end client 110 enters at step 206 is a market order. A market order specifies a number of shares to buy or sell, but does not include a particular price. Instead, a market order is to be executed “at the market price.” In another embodiment the order that end client 110 enters at step 206 is a limit order. A limit order specifies a number of shares, and also includes a limit price to either buy or sell the specified number of shares in the limit order. If the market price never reaches the limit price of the limit order, the limit order is not executed.

In one embodiment of the invention, the fact that an order is entered by end client 110 into crossing engine 102 is hidden from other end clients (112, 114). The fact of the order is also hidden from all market makers/liquidity providers (104, 106, 108) until there is an execution.

At step 210, crossing engine 102 receives the “firm order” entered by market maker/liquidity provider 104 at step 202, and the order entered at step 206 by end client 110.

Once crossing engine 102 has received the orders at step 210, it then considers the terms of each order to determine whether there is a possible match or cross. For example, the orders must be for the same security, and one order must be to buy while the other order must be to sell. In addition, crossing engine 102 may have priority or precedence rules that give priority in a match or cross to earlier entered orders, larger size orders, or to orders at superior prices.

As described elsewhere, a market maker/liquidity provider has no knowledge of other “firm orders” entered by other market makers/liquidity providers. In addition, a market maker/liquidity provider has no knowledge of end client orders until they receive a report of an execution. A market maker/liquidity provider can request a cancellation of a “firm order,” but as described below, the system may not grant the request if crossing engine 102 has already locked-in the “firm order.”

At step 212, crossing engine 102 determines whether the size of the order entered at step 206 by end client 110 is greater than the size of the “firm order” entered at step 202 by market maker/liquidity provider 104. Up to this point, a request from market maker/liquidity provider 104 to cancel the “firm order” would likely be granted because the “firm order” is not yet locked-in.

If the end client order is larger than the “firm order,” then at step 213, crossing engine 102 locks-in the “firm order.” Once locked-in, any request from market maker/liquidity provider 104 to cancel the “firm order” will be denied.

At step 214, crossing engine 102 calculates the excess size. As an example, if the “firm order” entered at step 202 is to buy 1,000 shares of GE, and the end client order entered at step 206 is a market order to sell 1,500 shares of GE, the excess size calculated at step 214 is 500 shares to sell of GE. At the same time the excess size is determined at step 214, the cross size is also determined. Together, the cross size and the excess size equal the order size that was entered at step 206.

At step 216, crossing engine 102 creates an order for the excess size and sends the order to a market for execution. In the GE example above, this is a market order to sell 500 shares of GE. In one embodiment, crossing engine 102 sends this order to the listing exchange for the security (e.g., GE is listed by NYSE, so the order is sent to NYSE for execution). In another embodiment, crossing engine 102 sends this order to any registered securities exchange for execution. If the “firm order” was not locked-in at step 213, then just before sending the order for the excess size to a market for execution, crossing engine 102 locks-in the “firm order.”

At step 218, crossing engine 102 determines the execution price(s) for the order sent to a market for execution at step 216. Typically, this means that crossing engine 102 receives a report of the execution or details of the execution. It is possible that the order is executed in multiple trades at different prices, and the execution report includes the execution price(s) and respective quantity at each price for the execution. The report may also identify the opposite parties.

At step 220, crossing engine 102 determines the best bid price or the best offer price (BBO) for the security. In one embodiment, this is the national best bid or offer, or NBBO. In another embodiment, this is the best bid price or best offer price published by any exchange.

At step 222, crossing engine 102 uses the best bid price or the best offer price as the execution price for the cross size, which was calculated at step 214.

At step 224, crossing engine 102 reports the execution and price(s) to market maker/liquidity provider 104 and end client 110.

If, at step 212, crossing engine 102 determines that the size of the order entered at step 206 by end client 110 is not greater than the size of the “firm order” entered at step 202 by market maker/liquidity provider 104, then, at step 219, crossing engine 102 locks-in the “firm order.”

At step 220, crossing engine 102 determines the best bid price or the best offer price (BBO) for the security. Because there is no excess size, the cross size equals the order size entered at step 206, and at step 222, crossing engine 102 uses the best bid price or the best offer price as the execution price for the cross size.

At step 224, crossing engine 102 reports the execution and price(s) to market maker/liquidity provider 104 and end client 110.

Additional Example Method

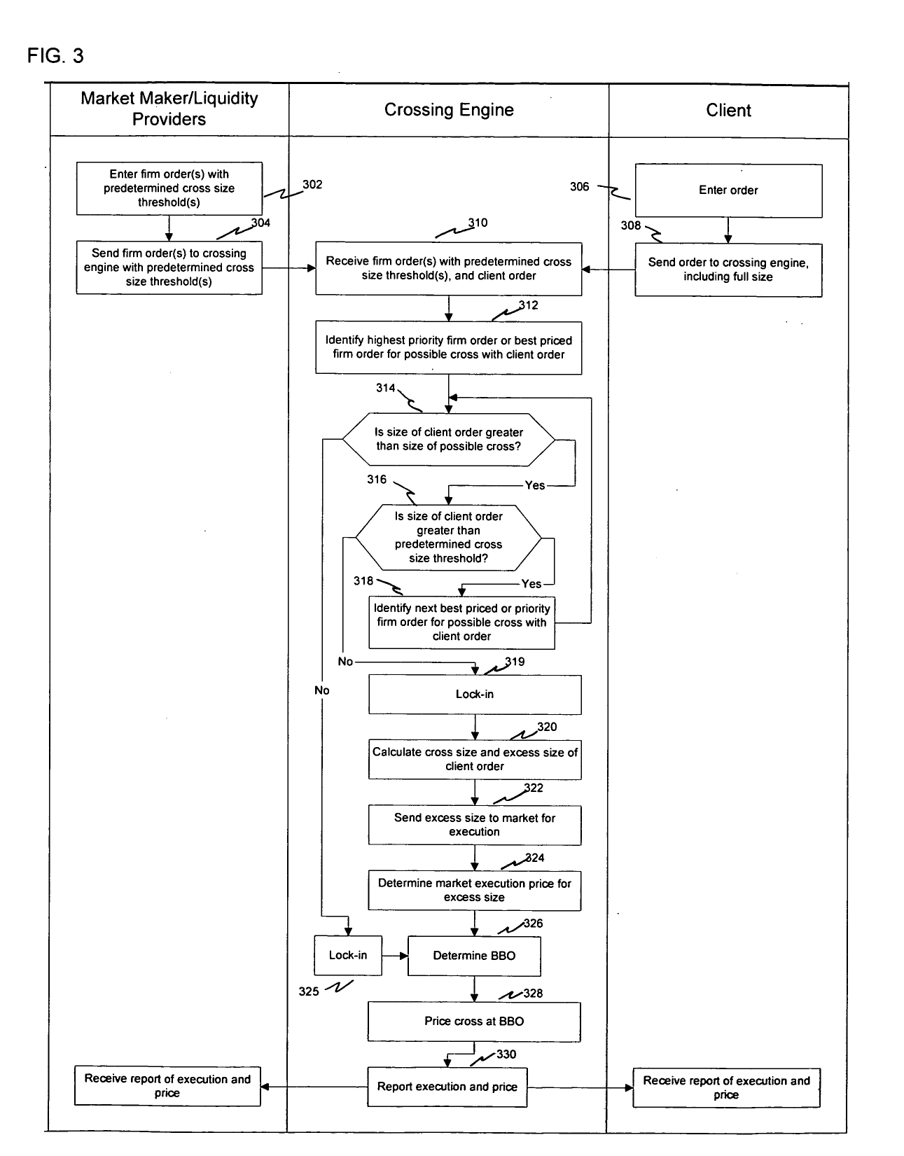

Having described some embodiments of the invention above, additional embodiments are illustrated in FIG. 3, where at step 302, market makers/liquidity providers (104, 106, 108) enter “firm orders” with predetermined cross size thresholds.

At step 304, market makers/liquidity providers (104, 106, 108) send the “firm orders” with predetermined cross size thresholds to crossing engine 102.

At step 306, end client 110 enters an order, and at step 308, end client 110 sends the order to crossing engine 102. In one embodiment, the order that end client 110 enters at step 306 is a market order. In another embodiment the order that end client 110 enters at step 306 is a limit order.

At step 310, crossing engine 102 receives the “firm order” entered by market maker/liquidity provider 104 at step 302, and the order entered at step 306 by end client 110.

At step 312, crossing engine 102 identifies the best priced “firm order” entered at step 302, or the highest priority “firm order” entered at step 302, for possible match or cross with the end client order entered at step 306. As before, the orders must be for the same security and one order must be to buy while the other order must be to sell. Priority may be based on time of order entry, or size of the order.

At step 314, crossing engine 102 determines whether the size of the order entered at step 306 by end client 110 is greater than the size of the “firm order” entered at step 302 by market maker/liquidity provider 104.

If, at step 314, crossing engine 102 determines that the end client order is larger than the “firm order,” then at step 316, crossing engine 102 determines whether the size of the order entered at step 306 by end client 110 is greater than the predetermined cross size threshold set by market maker/liquidity provider at step 302.

If, at step 316, crossing engine 102 determines that the order entered at step 306 by end client 110 is greater than the predetermined cross size threshold set by market maker/liquidity provider at step 302, then at step 318, crossing engine 102 identifies the next best priced “firm order,” or the next highest priority “firm order” for possible match or cross with the end client order entered at step 306.

If, at step 316, crossing engine 102 determines that the size of the end client order entered at step 306 is not greater than the predetermined cross size threshold entered by market maker/liquidity provider 104 at step 302, then at step 319, crossing engine 102 locks-in the “firm order.

At step 320, crossing engine 102 calculates the excess size. At the same time that the excess size is determined at step 320, the cross size is also determined. Together, the cross size and the excess size equal the order size that was entered at step 306.

At step 322 crossing engine 102 creates an order for the excess size and sends the order to a market for execution. In one embodiment, crossing engine 102 sends this order to the listing exchange for the security (e.g., GE is listed by NYSE, so the order is sent to NYSE for execution.) In another embodiment, crossing engine 102 sends this order to any registered securities exchange for execution. As described above, if the “firm order” was not locked-in at step 319, then immediately before sending the order for the excess size to a market for execution in step 322, crossing engine 102 locks-in the “firm order.”

At step 324, crossing engine 102 determines the execution price(s) for the order sent to a market for execution at step 322. Typically, this means that crossing engine 102 receives a report of the execution or details of the execution. The execution report includes the execution price(s) and respective quantity at each price for the execution and may identify the opposite parties.

At step 326, crossing engine 102 determines the best bid price or the best offer price (BBO) for the security. In one embodiment, this is the national best bid and offer, or NBBO. In another embodiment, this is the best bid price or best offer price published by any exchange.

At step 328, crossing engine 102 uses the best bid price or the best offer price as the execution price for the cross size, which was calculated at step 320.

At step 330, crossing engine 102 reports the execution and price(s) to market maker/liquidity provider 104 and end client 110.

If, at step 314, crossing engine 102 determines that the size of the order entered at step 306 by end client 110 is not greater than the size of the “firm order” entered at step 302 by market maker/liquidity provider 104, then, at step 325, crossing engine 102 locks-in the “firm order.”

At step 326, crossing engine 102 determines the best bid price or the best offer price (BBO) for the security. Because there is no excess size, the cross size equals the order size entered at step 306, and at step 328, crossing engine 102 uses the best bid price or the best offer price as the execution price for the cross size.

At step 330, crossing engine 102 reports the execution and price(s) to market maker/liquidity provider 104 and end client 110.

Although illustrative embodiments have been described herein in detail, it should be noted and will be appreciated by those skilled in the art that numerous variations may be made within the scope of this invention without departing from the principles of this invention and without sacrificing its chief advantages.

In one embodiment, the system and method are double blind. The fact of orders and any information about orders entered by market makers/liquidity providers (104, 106, 108) and orders entered by end clients (110, 112, 114) is known only to crossing engine 102. This eliminates any information advantage to market makers/liquidity providers (104, 106, 108) from orders entered by end clients (110, 112, 114). Similarly, it eliminates any information advantage to end clients (110, 112, 114) from orders entered by market makers/liquidity providers (104, 106, 108).

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

I claim:

1. A method for crossing securities orders, the method comprising:
receiving a first order to buy or sell a particular security, the first order including at least information reflecting quantity of the first order;
receiving a second order to buy or sell the security, the second order including at least information reflecting price of the second order and information reflecting quantity of the second order, wherein the first order and second order are compatible for a cross;
identifying as a crossing size a quantity of the second order that is less than or equal to the quantity of the first order;
identifying as an excess size a quantity of the second order that is greater than the quantity of the first order;
creating a third order for the security, the third order having at least information reflecting a quantity that is equal to the excess size;
sending the third order to a securities market for execution;
determining a best bid or best offer price for the security; and
executing the crossing size of the second order at the best bid or best offer price.

2. A method according to claim 1, further comprising:
reporting the execution of the crossing size.

3. A method according to claim 1, further comprising:
determining an execution price of the third order executed at the securities market.

4. A method according to claim 3, further comprising:
sending a report of the execution of the third order, the report including the execution price of the third order.

5. A method according to claim 3, wherein determining the best bid or best offer price for the security occurs after determining an execution price of the third order.

6. A method according to claim 1, wherein the second order is a market order.

7. A method according to claim 1, wherein the second order is a limit order.

8. A method according to claim 1, wherein the first order is a firm order.

9. A method according to claim 1, wherein the third order is a limit order.

10. A method according to claim 1, wherein the third order is a market order.

11. A method according to claim 1, wherein the securities market is the listing market for the security.

12. A method according to claim 1, wherein the securities market is not the listing market for the security.

13. A method according to claim 1, wherein the best bid or best offer price is the national best bid price or best offer price.

14. A method according to claim 1, wherein the first order is received from a first party and the second order is received from a second party, the method further comprising withholding all information about the first order from the second party until after executing the crossing size.

15. A method according to claim 1, wherein the first order is received from a first party and the second order is received from a second party, the method further comprising withholding all information about the second order from the first party until after executing the crossing size.

16. A method according to claim 1, further comprising:
locking-in the first order before sending the third order to a securities market for execution.

17. A method for crossing securities orders, the method comprising:
receiving a plurality of first orders to buy or sell a particular security, the first orders including at least information reflecting quantity of the first orders and predetermined cross size thresholds;
receiving a second order to buy or sell the security, the second order including at least information reflecting price of the second order and information reflecting quantity of the second order, wherein at least two of the first orders and the second order are compatible for a cross;
identifying one of the plurality of first orders as having a highest priority;
determining whether the quantity of the second order is greater than the predetermined cross size threshold of the highest priority first order;
responsive to determining whether the quantity of the second order is greater than the predetermined cross size threshold of the highest priority first order, identifying one of the plurality of first orders as having a next highest priority; and
determining whether the quantity of the second order is greater than the predetermined cross size threshold of the next highest priority first order.

18. A method according to claim 17, wherein priority of the first order is based on time of the order.

19. A method according to claim 17, wherein priority of the first order is based on size of the order.

20. A method according to claim 17, further comprising:
identifying as a crossing size a quantity of the second order that is less than or equal to the quantity of the next highest priority first order;
determining a best bid price or best offer price for the security; and
executing the crossing size of the second order at the best bid price or the best offer price.

21. A method according to claim 20, further comprising:
locking-in the next-highest priority first order before executing the crossing size of the second order.

22. A method according to claim 17, further comprising:
identifying as an excess size a quantity of the second order that is greater than the quantity of the next highest priority first order;
creating a third order for the security, the third order having at least information reflecting a quantity that is equal to the excess size; and
sending the third order to a securities market for execution.

23. A method according to claim 22, further comprising:
locking-in the next highest priority first order before sending the third order to a securities market.

24. Computer executable software code transmitted as an information signal, the code for crossing securities orders, the code comprising:
code to receive a first order to buy or sell a particular security, the first order including at least information reflecting quantity of the first order;
code to receive a second order to buy or sell the security, the second order including at least information reflecting price of the second order and information reflecting quantity of the second order, wherein the first order and second order are compatible for a cross;
code to identify as a crossing size a quantity of the second order that is less than or equal to the quantity of the first order;
code to identify as an excess size a quantity of the second order that is greater than the quantity of the first order;
code to create a third order for the security, the third order having at least information reflecting a quantity that is equal to the excess size;
code to send the third order to a securities market for execution;
code to determine a best bid or best offer price for the security; and
code to execute the crossing size of the second order at the best bid or best offer price.

25. A computer-readable medium having computer executable software code stored thereon, the code for crossing securities orders, the code comprising:
code to receive a first order to buy or sell a particular security, the first order including at least information reflecting quantity of the first order;
code to receive a second order to buy or sell the security, the second order including at least information reflecting price of the second order and information reflecting quantity of the second order, wherein the first order and second order are compatible for a cross;
code to identify as a crossing size a quantity of the second order that is less than or equal to the quantity of the first order;
code to identify as an excess size a quantity of the second order that is greater than the quantity of the first order;
code to create a third order for the security, the third order having at least information reflecting a quantity that is equal to the excess size;
code to send the third order to a securities market for execution;
code to determine a best bid or best offer price for the security; and
code to execute the crossing size of the second order at the best bid or best offer price.

26. A programmed computer for crossing securities orders, comprising:
a memory having at least one region for storing computer executable program code; and
a processor for executing the program code stored in the memory; wherein the program code comprises:
code to receive a first order to buy or sell a particular security, the first order including at least information reflecting quantity of the first order;
code to receive a second order to buy or sell the security, the second order including at least information reflecting price of the second order and information reflecting quantity of the second order, wherein the first order and second order are compatible for a cross;
code to identify as a crossing size a quantity of the second order that is less than or equal to the quantity of the first order;
code to identify as an excess size a quantity of the second order that is greater than the quantity of the first order;
code to create a third order for the security, the third order having at least information reflecting a quantity that is equal to the excess size;
code to send the third order to a securities market for execution;
code to determine a best bid or best offer price for the security; and
code to execute the crossing size of the second order at the best bid or best offer price.

27. Computer executable software code transmitted as an information signal, the code for crossing securities orders, the code comprising:
code to receive a plurality of first orders to buy or sell a particular security, the first orders including at least information reflecting quantity of the first orders and predetermined cross size thresholds;
code to receive a second order to buy or sell the security, the second order including at least information reflecting price of the second order and information reflecting quantity of the second order, wherein at least two of the first orders and the second order are compatible for a cross;
code to identify one of the plurality of first orders as having a highest priority;
code to determine whether the quantity of the second order is greater than the predetermined cross size threshold of the highest priority first order;
responsive to determining whether the quantity of the second order is greater than the predetermined cross size threshold of the highest priority first order, code to identify one of the plurality of first orders as having a next highest priority; and
code to determine whether the quantity of the second order is greater than the predetermined cross size threshold of the next highest priority first order.

28. A computer-readable medium having computer executable software code stored thereon, the code for crossing securities orders, the code comprising:
code to receive a plurality of first orders to buy or sell a particular security, the first orders including at least information reflecting quantity of the first orders and predetermined cross size thresholds;
code to receive a second order to buy or sell the security, the second order including at least information reflecting price of the second order and information reflecting quantity of the second order, wherein at least two of the first orders and the second order are compatible for a cross;
code to identify one of the plurality of first orders as having a highest priority;
code to determine whether the quantity of the second order is greater than the predetermined cross size threshold of the highest priority first order;
responsive to determining whether the quantity of the second order is greater than the predetermined cross size threshold of the highest priority first order, code to identify one of the plurality of first orders as having a next highest priority; and
code to determine whether the quantity of the second order is greater than the predetermined cross size threshold of the next highest priority first order.

29. A programmed computer for crossing securities orders, comprising:
a memory having at least one region for storing computer executable program code; and
a processor for executing the program code stored in the memory; wherein the program code comprises:
code to receive a plurality of first orders to buy or sell a particular security, the first orders including at least information reflecting quantity of the first orders and predetermined cross size thresholds;
code to receive a second order to buy or sell the security, the second order including at least information reflecting price of the second order and information reflecting quantity of the second order, wherein at least two of the first orders and the second order are compatible for a cross;
code to identify one of the plurality of first orders as having a highest priority;
code to determine whether the quantity of the second order is greater than the predetermined cross size threshold of the highest priority first order;
responsive to determining whether the quantity of the second order is greater than the predetermined cross size threshold of the highest priority first order, code to identify one of the plurality of first orders as having a next highest priority; and
code to determine whether the quantity of the second order is greater than the predetermined cross size threshold of the next highest priority first order.

30. A system for crossing securities orders, the system comprising:
means for receiving a first order to buy or sell a particular security, the first order including at least information reflecting quantity of the first order;
means for receiving a second order to buy or sell the security, the second order including at least information reflecting price of the second order and information reflecting quantity of the second order, wherein the first order and second order are compatible for a cross;
means for identifying as a crossing size a quantity of the second order that is less than or equal to the quantity of the first order;
means for identifying as an excess size a quantity of the second order that is greater than the quantity of the first order;
means for creating a third order for the security, the third order having at least information reflecting a quantity that is equal to the excess size;
means for sending the third order to a securities market for execution;
means for determining a best bid or best offer price for the security; and
means for executing the crossing size of the second order at the best bid or best offer price.

31. A system for crossing securities orders, the system comprising:
means for receiving a plurality of first orders to buy or sell a particular security, the first orders including at least information reflecting quantity of the first orders and predetermined cross size thresholds;
means for receiving a second order to buy or sell the security, the second order including at least information reflecting price of the second order and information reflecting quantity of the second order, wherein at least two of the first orders and the second order are compatible for a cross;
means for identifying one of the plurality of first orders as having a highest priority;
means for determining whether the quantity of the second order is greater than the predetermined cross size threshold of the highest priority first order;
responsive to determining whether the quantity of the second order is greater than the predetermined cross size threshold of the highest priority first order, means for identifying one of the plurality of first orders as having a next highest priority; and
means for determining whether the quantity of the second order is greater than the predetermined cross size threshold of the next highest priority first order.
